(19) United States
(12) Patent Application Publication
(10) Pub. No.: US 2026/0061361 A1
(43) Pub. Date: Mar. 5, 2026

(54) COMBUSTOR

(71) Applicant: AMTECH AS, Bergen (NO)

(72) Inventors: Asbjørn STRAND, Bergen (NO); Kumar Ranjan ROUT, Bergen (NO); De CHEN, Bergen (NO)

(21) Appl. No.: 19/106,005

(22) PCT Filed: Aug. 18, 2023
(86) PCT No.: PCT/EP2023/072770

§ 371 Date: Feb. 24, 2025

(30) Foreign Application Priority Data
Aug. 24, 2022 (GB) 2212301.2

(51) Int. Cl. B01D 53/14; B01D 53/18; B01D 53/62; B01D 53/78; B01D 53/96; B01J 23/42; B01J 23/75; B01J 35/54; F23C 13/06; F23D 14/22; F23D 14/70; F23L 7/00

(52) U.S. Cl. CPC B01D 53/1425; B01D 53/1475; B01D 53/18; B01D 53/62; B01D 53/78; B01D 53/96; B01J 23/42; B01J 23/75; B01J 35/54; F23C 13/06; F23D 14/22; F23D 14/70; F23L 7/007; B01D 2252/20405; B01D 2252/20421; B01D 2252/20484; B01D 2257/504; B01D 2258/0283

(57) ABSTRACT

A heating tube for supporting the combustion of a fuel and an oxidant includes a tubular wall for containing a gas flow through the heating tube and a catalyst, contained by the tubular wall, for catalysing a combustion reaction of a gaseous fuel and a gaseous oxidant.

### FIELD

The present disclosure relates to a combustion system. The combustion system according to embodiments may be used in a reboiler of a gas capture system.

### BACKGROUND

There is a lot of environmental pressure to reduce the emissions of carbon dioxide gas into the atmosphere. A known technology for greatly reducing the carbon dioxide released into the atmosphere is carbon capture and storage, CCS. A post-combustion carbon dioxide capture, PCCC, system removes carbon dioxide from a flue gas generated by carbon dioxide combustion prior to the flue gas being released into the atmosphere. A PCCC system may be retrofitted to an existing flue gas source, such as a fossil fuel-fired power plant or combustion engine, in order for CCS to be implemented. In a PCCC system, a sorbent is used to capture, e.g. adsorb/absorb, carbon dioxide from flue gas. The sorbent may be a liquid and known liquid sorbents include monoethanolamine (MEA).

There is a need to improve known CCS systems. More generally, there is a need to improve gas capture systems across a plurality of applications, including the capture of gasses other than carbon dioxide. Even more generally, there is a need to improve the apparatus used in gas capture systems.

### SUMMARY OF THE INVENTION

Aspects of the invention are set out in the appended independent claims. Optional aspects are set out in the dependent claims.

### LIST OF FIGURES

The invention is described below, by way of example only, with reference to the drawings, in which:

FIG. 1 schematically shows a known gas capture system based on the circulation of a liquid sorbent;

FIG. 2 schematically shows a known reboiler for use in a gas capture system;

FIG. 3 schematically shows a reboiler according to an embodiment;

FIGS. 4A and 4B schematically show a heating tube according to an embodiment;

FIGS. 5A and 5B schematically show a heating tube according to an embodiment; and

FIG. 6 schematically shows a reboiler according to an embodiment.

The following description is merely exemplary in nature and is not intended to limit the scope of the present invention, which is defined in the claims. It should be understood that throughout the drawings, corresponding reference numerals indicate like or corresponding parts and features.

### DESCRIPTION

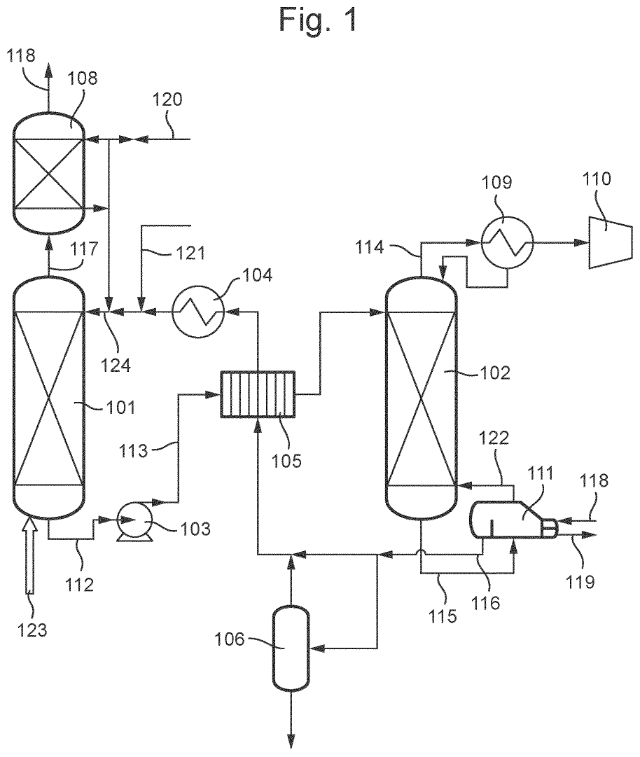

FIG. 1 schematically shows a known gas capture process based on the circulation of a liquid sorbent.

Gas capture reactor 101 receives a carbonaceous gas, such as a flue gas, that is supplied to it through the gas supply conduit 123. Gas capture reactor 101 also receives a liquid sorbent through the sorbent supply conduit 124. The received gas and sorbent are brought into contact within the gas capture reactor 101 and the sorbent captures, by adsorption and/or absorption, at least some of the carbon dioxide in the received gas. The gas may flow out of the gas capture reactor 101 through the gas output conduit 117, through a washing reactor 108, and into a gas capture system output conduit 118. In the washing reactor 108, the gas may be washed with water, that is supplied through conduit 120, to substantially reduce the amount of sorbent in the gas. The gas capture system output conduit 118 may therefore comprise a cleaned gas, i.e. the gas has a substantially lower carbon dioxide concentration that the supplied gas through the gas supply conduit 123.

The sorbent that is supplied to the gas capture reactor 101 may be referred to as a lean sorbent because it is in a state for capturing a gas. The sorbent that is output from the gas capture reactor 101 may be referred to as a rich sorbent because it is in a state for releasing a captured gas.

The rich sorbent may flow out of the gas capture reactor 101 through the conduit 112, through a pump 103, through a heat exchanger 105 and into a sorbent regeneration reactor 102. The sorbent regeneration reactor 102 also receives a hot gas through conduit 122. The substantial component of the hot gas may be steam. Within the sorbent regeneration reactor 102, the hot gas heats the sorbent, at a temperature that may be about 100° C. to 150° C., and the sorbent releases at least some of the captured gas. The released gas, i.e. carbon dioxide, flows out of the sorbent regeneration reactor 102, through the condenser 109 (where any steam may be condensed out), and to a compressor 110 where it may be liquefied so that it is suitable for transportation.

The sorbent flows out of the sorbent regeneration reactor 102, through conduit 115, and is supplied to the reboiler 111. Within the reboiler 111, the sorbent is heated to generate the hot gas that is supplied to the sorbent regeneration reactor 102 through conduit 122. The sorbent that flows out of the reboiler 111, through conduit 116, is a lean sorbent. Some of the sorbent may be flow to a reclaimer 106 which generates a flow of reclaimed sorbent for use and a flow of sludge out of the gas capture system. The main flow of the lean sorbent, in conduit 116, may be to the heat exchanger 105. The heat exchanger may cool the lean sorbent, and heat the rich sorbent, by heat exchange between the different sorbent flows. The lean sorbent may flow through a cooler 104, that cools it to a temperature appropriate for the gas capture process, and back to the to the gas capture reactor 101 through conduit 124. Accordingly, the liquid sorbent is cycled between gas capture and gas release processes. Fresh sorbent may also be supplied into the sorbent flow through conduit 121.

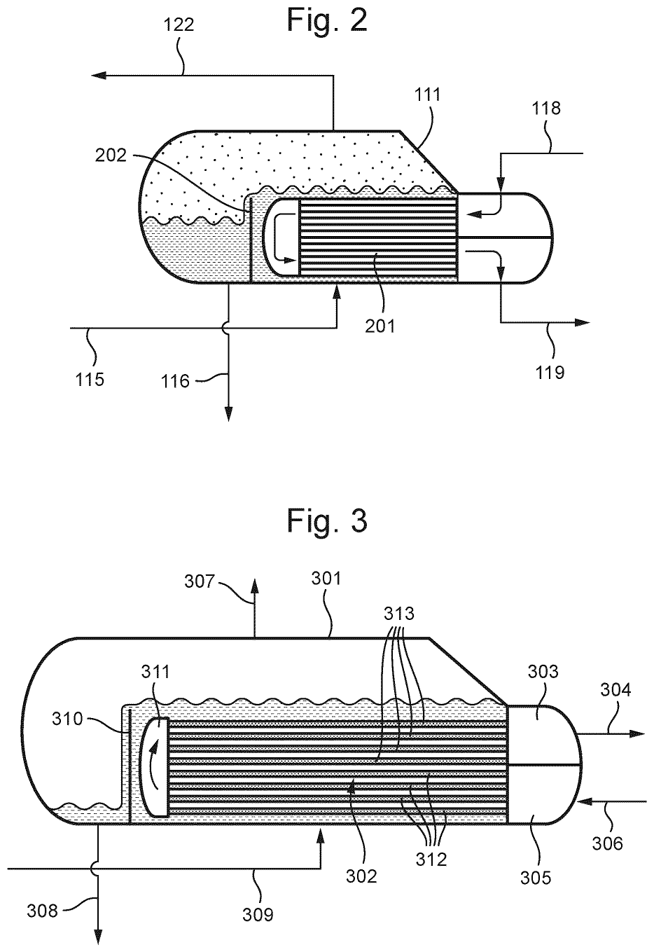

FIG. 2 schematically shows the reboiler 111 of FIG. 1 in more detail. The sorbent is supplied to a sorbent heating region 201 of the reboiler through conduit 115. The sorbent heating region 201 comprises hot pipes that heat the sorbent. The heating substantially evaporates the water component of the sorbent and the evaporate, i.e. steam, is the substantial component of the hot gas that flows out of the reboiler 111 through conduit 122. The hot pipes are heated by a flow of steam into the reboiler 111 through conduit 118. The steam supplied through conduit 118 may condense in the hot pipes and flow out of the reboiler 111 as water through conduit 119. The sorbent heating region 201 within the reboiler 111 may comprise an internal containing wall 202 that the sorbent heated in the sorbent heating region 201 flows over.

Embodiments improve on the above-described known techniques.

The above described known gas capture system requires a steam generator that supplies steam to the reboiler 111 through conduit 118. The steam generator is a separate and independently operated apparatus from the rest of the gas capture system. The steam generation is therefore inefficient. Furthermore, the steam may be generated by combusting a carbonaceous fuel and the carbon dioxide that is generated by this is not captured.

Embodiments provide a new reboiler that improves on known reboilers 111. A particularly advantageous use of the reboiler according to embodiments is in a gas capture system.

FIG. 3 schematically shows a reboiler 301 according to an embodiment. The reboiler 301 comprises a fluid supply conduit 309 arranged to supply the fluid that is heated in the reboiler. The fluid in the fluid supply conduit 309 may be only a liquid, or a mixture of a liquid and a gas. When the reboiler 301 according to the present embodiment is used as the reboiler of the gas capture system shown in FIG. 1, the fluid supply conduit 309 may be the same as the conduit 115 that supplies sorbent output from the sorbent regeneration reactor 102 to the reboiler 111.

The reboiler 301 comprises a heating region 302. A plurality of heating tubes 312, 313 pass through the heating region 302. The fluid supply conduit 309 is arranged to supply fluid to the heating region 302. The supplied fluid may be temporarily contained in the heating region 302 by the internal containing wall 310 until the supplied fluid flows up to the level of the containing wall 310. The fluid may be heated in the heating region 302 by the heating tubes 312, 313. The heating by the heating tubes 312, 313 may cause a liquid component of the supplied fluid to evaporate and thereby generate a gas within the reboiler 301. The gas may flow out of the reboiler 301 through the gas output conduit 307. The liquid that flows over the top of the containing wall 310 may flow out of the reboiler 301 through the fluid output conduit 308.

When the supplied fluid to the reboiler 301 is a mixture of a liquid sorbent and water, some, or all, of the water may evaporate in the heating region 302 so that steam is the substantial component of the gas that flows out of the reboiler 301 through the gas output conduit 307. The substantial component of the liquid that flows out of the fluid output conduit 308 may be liquid sorbent.

A substantial difference between the reboiler 301 according to embodiments and known reboilers is the way that the heat in the heating region 302 is generated. Embodiments include a new type of combustion system in the reboiler 301 for generating heat.

The combustion system of the reboiler 301 according to embodiments may comprise all of a pre-combustion chamber 305, an end chamber 311, an exhaust collection chamber 303, a first set of heating tubes 312 and a second set of heating tubes 313. One or more fuel supply conduits 306 may be arranged to supply both fuel and an oxidant to the pre-combustion chamber 305. The first set of heating tubes 312 may provide a contained flow path from the pre-combustion chamber 305 to the end chamber 311. The second set of heating tubes 313 may provide a contained flow path from the end chamber 311 to the exhaust collection chamber 303. One or more exhaust output conduits 304 may be arranged to provide a flow of exhaust gas out of the reboiler 301. The heating tubes 312, 313 are preferably arranged to so that a total combustion reaction occurs within them.

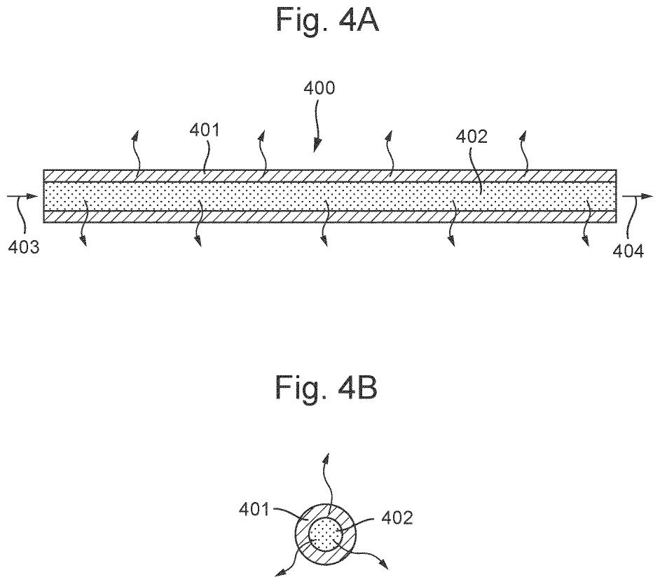

FIGS. 4A and 4B schematically show a heating tube 400 according to an embodiment. The heating tube 400 may be used as a heating tube in the first set of heating tubes 312 or the second set of heating tubes 313 as shown in FIG. 3. The wavy lines in FIGS. 4A and 4B show flows of heat flux from inside the heating tube 400 to outside of the heating tube 400.

As shown in FIGS. 4A and 4B, the heating tube 400 comprises a tubular wall 401. There is an input gas flow 403 into the heating tube 400 and an output gas flow 404 from the heating tube 400. The tubular wall 401 contains as gas flow through the heating tube 400. The contained region by the tubular wall 401 may be referred to as a combustion region of the heating tube 400. The heating tube 400 comprises a catalyst 402 within the flow path of gas through the heating tube 400. The catalyst may be provided as a packed bed of pellets.

The input gas flow 403 may be a gas mixture that comprises a fuel and an oxidant. The fuel may be, for example, natural gas, bio gas or syngas. The oxidant may be, for example, air, substantially pure oxygen, or oxygen rich turbine flue gas. The catalyst may be a promoter of total combustion of the fuel and oxidant. The ignition between the fuel and oxidant may by started by an ignitor and occur before the fuel and oxidant have flowed into the heating tube 400, such as in the pre-combustion chamber 305 as shown in FIG. 3. Alternatively, the ignition between the fuel and oxidant may be started by an ignitor within the heating tube 400.

The catalyst may comprise one or more of Cobalt, Platinum, or other constituents for promoting the total combustion process between the fuel and oxidant. The catalyst may be provided as solid pellets. The catalyst pellets may support a controlled heterogeneous combustion on their surface. This results in heat being generated at a near even rate along the length of the heating tube 400. Preferably, the catalyst pellets have a significant thermal mass and good heat conductivity. This will help to prevent substantial heat fluctuations and substantial hot spots occurring and provide a substantially even heat flux along the wall 401 of the heating tube 400.

By appropriate configuration of the heating tube 400, the rate of heat generation along the length of the heating tube 400 and the heat flux through the wall 401 provide a substantially constant temperature within in the combustion region as well as on the outer surface of the wall 401.

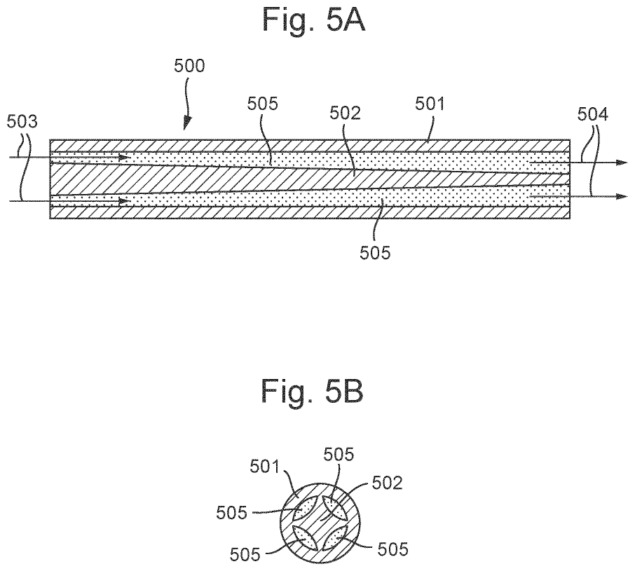

FIGS. 5A and 5B schematically show a heating tube 500 according to another embodiment. The heating tube 500 comprises a tubular wall 501. There is an input gas flow 503 into the heating tube 500 and an output gas flow 504 from the heating tube 500. The tubular wall 501 contains as gas flow through the heating tube 500. The contained region by the tubular wall 501 may be referred to as a combustion region of the heating tube 500. The heating tube 500 comprises a catalyst 505 within the flow path of gas through the heating tube 500. The catalyst 505 may be provided as a packed bed of pellets.

The gas flow into the heating tube 500 may be the same as the gas mixture that comprises a fuel and an oxidant as described earlier for the heating tube 400 shown in FIGS. 4A and 4B. The catalyst 505 may be the same as the catalyst 402 as described earlier for the heating tube shown in FIGS. 4A and 4B. The catalyst may therefore be a promoter of total combustion of the fuel and oxidant. The ignition between the fuel and oxidant may occur before the fuel and oxidant have flowed into the heating tube 500, such as in the pre-combustion chamber 305 as shown in FIG. 3. Alternatively, the ignition between the fuel and oxidant may occur within the heating tube 500.

The heating tube 500 shown in FIGS. 5A and 5B may comprise an a passive fluid flow adjustor 502. The passive fluid flow adjustor 502 may be contained within, and supported by, the wall 501 of the heating tube 500. The passive fluid flow adjustor 502 may comprise one or more concentric variable cross section inserts with support fins that may extend to the inner surface of the wall 501. As shown in FIG. 5A, the cross-sectional area of the passive fluid flow adjustor 502 may vary along the length of the heating tube 500. This may vary the gas flow rate along length of the heating tube 500. In particular, the passive fluid flow adjustor 502 may be configured so that the gas flow rate is higher in the parts of the heating tube 500 with a higher combustion rate. The passive fluid flow adjustor 502 may thereby even out the heat generation flux along the length of the heating tube 500. A further advantages of the passive fluid flow adjustor 502 is that it may improve the heat conduction to the wall 501.

Another embodiment, that may be used in both of the above-described embodiments of heating tube 400, 500, comprises using inert pellets to locally change the concentration of the catalyst 402, 505. By varying the local ratio of inert pellets to catalyst pellets along the heating tube 400, 500, the variation of the concentration of the catalyst 402, 505 results in variable heat flux generation along the heating tube 400, 500. The local ratios of inert pellets to catalyst pellets may be configured so as to ensure that the heating tube 400, 500 has a substantially constant temperature along its length.

An advantage of the above-described embodiments of heating tube 400, 500 is that the temperature of the heating tube 400, 500 is substantially constant along the length of the wall 401, 501 of the heating tube 400, 500. The heating tube 400, 500 may also be configured to provide a desired temperature by the content of the supplied gas mixture, the type of catalyst used, the use of a passive fluid flow adjustor 502 and/or the use of inert pellets.

All of the above-described embodiments of heating tube 400, 500 may be used as a heating tube in the first set of heating tubes 312 or the second set of heating tubes 313 as shown in FIG. 3. The supplied fluid by the fluid supply conduit 309 may flow over the outer surfaces of the heating tubes 311, 312 in the heating region 302.

All of the above-described embodiments of heating tube 400, 500 may be made of steel. Each catalyst pellet may be, for example, a block in the gas flow path with the block coated with the catalyst. The block may, for example, be made of ceramic. Within each heating tube 400, 500, the catalyst pellets may consume about 60% of the volume. Each heating tube 400, 500 may be operated at a pressure of about 20 bar.

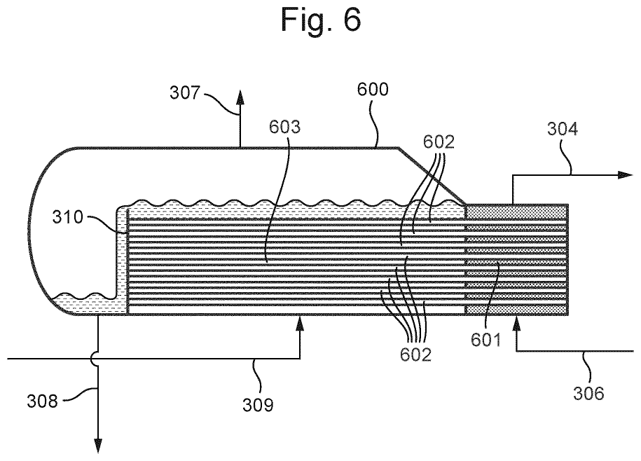

FIG. 6 schematically shows an another implementation of a combustion system of a reboiler 600 according to an embodiment. The combustion system comprises a heat generation region 601 and heat pipes 602 arranged to transfer heat from the heat generation region to a fluid heating region 302. The reboiler 600 may be used as the reboiler 111 of the gas capture system shown in FIG. 1.

The reboiler 600 comprises a fluid supply conduit 309 arranged to supply the fluid that is heated in the reboiler. The fluid in the fluid supply conduit 309 may be only a liquid, or a mixture of a liquid and a gas. When the reboiler 600 according to the present embodiment is used as the reboiler of the gas capture system shown in FIG. 1, the fluid supply conduit 309 may be the same as the conduit 115 that supplies sorbent output from the sorbent regeneration reactor 102 to the reboiler 111.

The reboiler 600 comprises the heat generation region 601. One or more fuel supply conduits 306 may be arranged to supply both fuel and an oxidant to the heat generation region 601. One or more exhaust output conduits 304 may be arranged to provide a flow of exhaust gas out of the heat generation region 601. The fuel and an oxidant supplied through the fuel supply conduits 306 may be the same as described earlier for the heating pipes 400 and 500. Accordingly, the fuel supply conduits 306 may comprise a gaseous mixture of a fuel and an oxidant. The fuel may be, for example, natural gas, bio gas or syngas. The oxidant may be, for example, air, substantially pure oxygen, or oxygen rich turbine flue gas.

The heat generation region 601 may comprise a fixed bed reactor with a catalyst for promoting the total combustion of the supplied fuel and oxidant.

The reboiler 600 comprises the fluid heating region 603. The plurality of heat pipes 602 extend across both the fluid heating region 603 and the heat generation region 601. The heat pipes 602 may transfer heat from heat generation region 601 to the fluid heating region 603. The fluid supply conduit 309 is arranged to supply fluid to the fluid heating region 603. The supplied fluid may be temporarily contained in the fluid heating region 603 by the internal containing wall 310 until the supplied fluid flows up to the level of the containing wall 310. The fluid may be heated in the fluid heating region 603 by the heat pipes 602. The heating by the heat pipes 602 may cause a liquid component of the supplied fluid to evaporate and thereby generate a gas within the reboiler 600. The gas may flow out of the reboiler 600 through the gas output conduit 307. The liquid that flows over the top of the containing wall 310 may flow out of the reboiler 600 through the fluid output conduit 308.

The heat pipes 602 may be standard known heat pipes 602 that comprise an evaporator part and an condenser part. The evaporator part of each heat pipe 602 is located in the heat generation region 601 and the condenser part of each heat pipe 602 is located in the fluid heating region 603. The heat pipes 602 efficiently transfer heat from the heat generation region 601 to the fluid heating region 603 with the walls of the heat pipes remaining at a substantially constant temperature.

The operating temperature of each heat pipe 602 will be dependent on the heat fluxes in its evaporator and condenser parts. The operating temperature of each heat pipe 602 may deviate substantially from the combustion temperature in the heat generation region 601 and may be controlled by the combustion rate, combustion temperature, the flow rate of the working fluid in the heat pipes 602, the fluid flow rate through the fluid heating region 603 and the temperature in the fluid heating region 603. The working fluid in the heat pipes 602 may be water and have an operational temperature of about 140-200° C. This may be a suitable temperature for the application of regenerating a liquid sorbent of CO₂, such as MEA.

Embodiments include the heating tubes 400, 500, as described with reference to FIGS. 4A to 5B. Embodiments include the heating tubes 400, 500 being used for any purpose. Embodiments also include the reboilers 301, 600, as described with reference to FIGS. 3 and 6. Embodiments include the reboilers 301, 600 being used for any purpose. Embodiments also include a gas capture system, such as the gas capture system shown in FIG. 1 or any other type of gas capture system, when the gas capture system comprises the reboilers 301, 600 according to embodiments.

In the reboiler of a liquid amine sorbent based CO₂ capture system, the amine sorbent will degrade if the temperature of the tubes/pipes used to heat the amine sorbent is too high. It may be necessary to maintain the temperature of the amine sorbent to below about 200° C. The reboilers 301, 600 according to embodiments include generating heat by a catalytic total combustion process that may be performed at a substantially higher temperature that what the amine sorbent is heated to. For example, the catalytic total combustion process may occur at about 300° C. This is possible through appropriate thermal design and process control. The thermal design features may include the wall thickness of the heating tubes and/or heat pipes, the structure of the passive fluid flow adjustors 502, the heat exchange coefficients on inner wall and outer wall of the heating tubes and/or heat pipes, as well as other features. The process control includes control of the fluid flow rates, superficial gas velocity, pressure, and combustion rate.

The exhaust gas from the total combustion process in the reboilers 301, 600 according to embodiments may be supplied to the gas capture reactor of a gas capture system. In particular, when the reboilers 301, 600 are used in a gas capture system such as the gas capture system shown in FIG. 1, the exhaust gas from the total combustion process in the reboilers 301, 600 may be provided, via a conduit, to the same gas capture reactor 101 of the gas capture system. The reboilers 301, 600 according to embodiments may thereby be integrated into the gas capture system.

In a preferred application of the gas capture system embodiments, the gas being cleaned is a flue gas from a combustion process. However, the gas capture system of embodiments may be used to capture a gas from any gas mixture and are not restricted to being used for cleaning a flue gas. The gas to be cleaned may be referred to as a dirty gas. The dirty gas may be, for example, sour gas directly output from a well head. The sour gas would be cleaned by capturing the hydrogen sulphide content. Embodiments also include gas capture systems for cleaning gasses in industries such as the power generation industry, the metal production industry, cement production industry and mineral processing industry. In particular, gas capture systems according to embodiments can be used to clean gasses from cement production processes, blast furnace processes, steel production processes and reforming processes (e.g. for hydrogen production).

All of the components of the gas capture systems of embodiments are scalable such that implementations of embodiments are appropriate for small, medium and large industrial scale processes. For example, implementations of embodiments may be used to clean flue gas from small to medium scale engines. Larger implementations of embodiments may be used to clean flue gas from a power plant/station.

Another preferred application of the gas capture system of embodiments is in a hydrogen production process. It is known for hydrogen to be produced by sorption-enhanced reforming, SER, and/or by a water gas shift process. These processes may convert methane and steam to a gas mixture comprising hydrogen and carbon dioxide. The gas capture systems of embodiments may separating the generated hydrogen and carbon dioxide in order to obtain substantially pure hydrogen.

Embodiments include a number of modifications and variations to the above-described processes.

In the above-described embodiments, a catalytic total combustion process is used to generate heat. Embodiments also include the use of a non-catalytic combustion process and/or a non-total combustion process.

Embodiments include the above described heating tubes 400, 500 being used as the heating tubes in other apparatuses than reboilers 301, 600.

The foregoing description of the preferred embodiments has been provided for the purposes of illustration and description. Individual elements or features of a particular embodiment are generally not limited to that particular embodiment, but where applicable may be interchangeably used in combination with other features to define another embodiment, even if not specifically shown or described. The description is therefore not intended to limit the scope of the present invention, which is defined in the claims.

1. A heating tube for supporting the combustion of a fuel and an oxidant, the heating tube comprising:
a tubular wall for containing a gas flow through the heating tube; and
a catalyst, contained by the tubular wall, for catalysing a combustion reaction of a gaseous fuel and a gaseous oxidant.

2. The heating tube according to claim 1, wherein the catalyst is provided by catalyst pellets.

3. The heating tube according to claim 2, wherein the pellets are a packed bed within the heating tube.

4. The heating tube according to claim 1, further comprising a fluid flow adjustor, wherein:
the fluid flow adjustor is contained by the tubular wall and is in thea gas flow path; and
the fluid flow adjustor has a variable cross-section along its length such that thea cross-sectional area of the gas flow path is varied along the length of the heating tube.

5. The heating tube according to claim 1, further comprising a fluid flow adjustor that is an insert of the heating tube.

6. The heating tube according to claim 1, further comprising a fluid flow adjustor that comprises fins.

7. The heating tube according to claim 1, wherein, in use, received gas by the heating tube comprises a gaseous carbonaceous fuel.

8. The heating tube according to claim 1, wherein, in use, received gas by the heating tube comprises one or more of natural gas, bio gas or syngas.

9. The heating tube according to claim 1, wherein, in use, received gas by the heating tube comprises a gaseous oxidant that comprises one or more of air, substantially pure oxygen, or oxygen rich turbine flue gas.

10. The heating tube according to claim 1, further comprising inert pellets that comprise an inert material to the combustion reaction.

11. The heating tube according to claim 1, wherein the catalyst is provided by catalyst pellets, the heating tube further comprises inert pellets that comprise an inert material to the combustion reaction, the inert pellets are mixed with the catalyst pellets, and
a local ratio of inert pellets to catalyst pellets varies along a length of the heating tube.

12. The heating tube according to claim 1, wherein, in use, the catalyst supports a total combustion process between the fuel and the oxidant.

13. The heating tube according to claim 1, wherein the catalyst comprises Cobalt and/or Platinum.

14. A reboiler for separating constituents of a fluid mixture, the reboiler comprising:
a fluid inlet for receiving a fluid mixture;
a fluid heating region comprising one or more heating tubes, wherein each heating tube is arranged to heat the fluid mixture so as to evaporate a liquid constituent of the received fluid mixture;
a first fluid outlet for providing flow of liquid out of the reboiler; and
a second fluid outlet for providing flow of gas out of the reboiler2
wherein each heating tube is configured to support combustion of a fuel and an oxidant and comprises:
a tubular wall for containing a gas flow through the heating tube; and
a catalyst, contained by the tubular wall, for catalysing a combustion reaction of a gaseous fuel and a gaseous oxidant.

15. The reboiler according to claim 14, further comprising a pre-combustion chamber arranged to receive flows of fuel and oxidant before the fuel and oxidant is supplied to the one or more heating tubes; and
an ignitor arranged to ignite the mixture of fuel and oxidant in the pre-combustion chamber.

16. (canceled)

17. (canceled)

18. (canceled)

19. A gas capture system for capturing one or more gasses in a gas mixture, the gas capture system comprising:
a gas capture reactor arranged to react a gas mixture with a liquid sorbent such that at least some of a gas in the gas mixture is captured by the sorbent;
a sorbent regeneration reactor arranged to heat the sorbent with steam such that the sorbent releases at least some of the gas captured in the gas capture reactor;
a reboiler arranged to evaporate water from the sorbent, wherein the reboiler is according to claim 14; and
a sorbent looping system arranged to recirculate the sorbent around a sorbent flow path that comprises the gas capture reactor, the sorbent regeneration reactor and the reboiler.

20. The gas capture system according to claim 19, further comprising a gas flow path from the reboiler to the gas capture reactor arranged to feed exhaust gas form the reboiler to the gas capture reactor.
